(19) United States
(12) Patent Application Publication
(10) Pub. No.: US 2024/0142347 A1
(43) Pub. Date: May 2, 2024

(54) SYSTEM FOR DIAGNOSING MACHINE FAILURE ON BASIS OF ADVANCED DEEP TEMPORAL CLUSTERING MODEL

(71) Applicant: Kyungpook National University Industry-Academic Cooperation Foundation, Daegu (KR)

(72) Inventors: Dongjun SUH, Gimcheon-si, Gyeongsangbuk-do (KR); Geonkyo HONG, Daejeon (KR); Jeonghoon CHOI, Sangju-si Gyeongsangbuk-do (KR)

(73) Assignee: Kyungpook National University Industry-Academic Cooperation Foundation, Daegu (KR)

(21) Appl. No.: 18/280,272

(22) PCT Filed: Dec. 29, 2021
(86) PCT No.: PCT/KR2021/020139

§ 371 Date: Sep. 5, 2023

(30) Foreign Application Priority Data
Mar. 5, 2021 (KR) 10-2021-0029428

(51) Int. Cl. G01M 99/00; G05B 23/02

(52) U.S. Cl. CPC G01M 99/005; G05B 23/0229

(57) ABSTRACT

A system for diagnosing a machine failure according to an embodiment of the inventive concept includes a pre-processing module that receives a primitive signal in a time-amplitude domain to generate a Mel spectrum image in a time-frequency domain, a feature extraction module that learns features of the Mel spectrum image to output an Euclidean distance between a latent variable and a centroid, a failure diagnosis module that performs classification into a preset number of classes on the basis of the Euclidean distance between the latent variable and the centroid, and a result output module that outputs whether a failure has occurred according to a class classified by the failure diagnosis module.

### TECHNICAL FIELD

The inventive concept relates to a system for diagnosing a machine failure based on an advanced deep temporal clustering model.

The inventive concept is derived from research conducted as part of Regional innovation growth sector of the Ministry of Science and ICT (Project No.; 1711137656, Research project name; Carbon Neutral Intelligent Energy System Regional Innovation Leading Research Center, project management institution; National Research Foundation of Korea, research period; 2020 Jun. 1.˜2022 Feb. 28).

In addition, the inventive concept is derived from research conducted as part of the local university excellent scientist support project by the Ministry of Education (Project No.; 1345334301, Research project name; Research on the development of core operation technologies for prosumer-type future distributed energy and smart virtual power plants using artificial intelligence and energy big data, project management institution; National Research Foundation of Korea, research period; 2020 Jun. 1.˜2022 Feb. 28.)

Meanwhile, there is no property interest of the Korean government in any aspect of the inventive concept.

### BACKGROUND ART

Artificial intelligence enables computers to learn data and make decisions on their own, just like humans.

For example, it is necessary to teach a computer what the subject is in a photograph while continuously showing the computer photographs in order to create a classification model that classifies a photograph when looking at the photograph. This method is called ‘supervised machine learning’.

Unlike this, a computer performs clustering and learning according to its own criteria without being told the correct answer to the subject in a photograph, which is called ‘unsupervised machine learning’.

Existing machine learning algorithms are mostly based on supervised machine learning. Supervised machine learning is a method of teaching a computer information first. For example, it is a method of giving a computer a picture and telling the computer that ‘this picture is about a cat’. The computer classifies cat photos based on pre-learning results.

In unsupervised machine learning, the computer learns on its own without this learning process. Therefore, unsupervised machine learning requires high computational power of a computer.

The field of mechanical and electronic equipment to which the inventive concept is to be applied is exposed to a risk of failure, and the longer the use time, the higher the risk of failure.

When mechanical equipment in a manufacturing plant or processing plant fails, it has a great impact on product productivity and profitability, causes industrial accidents, spends a lot of money on follow-up measures, and causes inconvenience in not being able to use it when necessary. However, it is difficult to identify the cause of failure of mechanical equipment, and despite the cause of failure (defective parts) remaining in mechanical equipment, the situation is simply coped with, hoping that the mechanical equipment will operate for a vaguely long time.

In other words, in order to diagnose the failure of mechanical equipment, it is necessary to identify the cause of failure (defect of parts) of parts constituting the mechanical equipment, but approaches that rely on analyzing data measured from the parts constituting the mechanical equipment can't accurately identify the cause of failure of mechanical equipment, so that, in the industrial field, there was a problem that the cause of failure of mechanical equipment is identified by relying on the empirical analysis of experts.

To solve these problems, Korean Registered Patent Publication 10-2027389 provides a mechanical equipment failure diagnosis device using an autoencoder, K-means, and Support Vector Machine, capable of accurately diagnosing the type and cause of failure of parts of mechanical equipment using an artificial neural network embedded with an autoencoder and a deep learning model.

### DETAILED DESCRIPTION OF THE INVENTION

### Technical Problem

An embodiment of the present invention aims to provide a system for diagnosing a machine failure, capable of outputting a Euclidean distance between latent variables and centroids using an autoencoder and a K-means clustering algorithm, classifying the output Euclidean distance into a predetermined number of classes by finding the boundaries of features located in a vector space using an SVM algorithm maximizing the margins, and outputting whether the machine has a failure or not.

Meanwhile, the technical problems to be solved by the inventive concept are not limited to the aforementioned problems, and any other technical problems not mentioned herein will be clearly understood from the following description by those skilled in the art to which the inventive concept pertains.

### Technical Solution

A system for diagnosing a machine failure according to an embodiment of the inventive concept includes a pre-processing module that receives a primitive signal in a time-amplitude domain to generate a Mel spectrum image in a time-frequency domain, a feature extraction module that learns features of the Mel spectrum image to output an Euclidean distance between a latent variable and a centroid, a failure diagnosis module that performs classification into a preset number of classes on the basis of the Euclidean distance between the latent variable and the centroid, and a result output module that outputs whether a failure has occurred according to a class classified by the failure diagnosis module.

### Advantageous Effects of the Invention

The system for diagnosing a machine failure according to the embodiment of the inventive concept can output a Euclidean distance between latent variables and centroids using an autoencoder and a K-means clustering algorithm, classify the output Euclidean distance into a predetermined number of classes by finding the boundaries of features located in a vector space using an SVM algorithm maximizing the margins, and output whether the machine has a failure or not.

Meanwhile, the effects obtainable the inventive concept are not limited to the aforementioned effects, and any other effects not mentioned herein will be clearly understood from the following description by those skilled in the art to which the inventive concept pertains.

### DESCRIPTION OF THE DRAWINGS

FIG. 1 is a diagram schematically showing a system for diagnosing a machine failure according to an embodiment of the inventive concept.

FIG. 2 is a diagram schematically illustrating a data flow performed in each configuration of FIG. 1.

FIGS. 3 and 4 are diagrams showing a primitive signal and a Mel spectrum image when a bearing is in a normal state.

FIGS. 5 and 6 are diagrams showing a primitive signal and a Mel spectrum image when there is a ball fault in 0.007-inch bearing.

FIGS. 7 and 8 are diagrams showing a primitive signal and a Mel spectrum image when there is a ball fault in 0.014-inch bearing.

FIGS. 9 and 10 are diagrams showing a primitive signal and a Mel spectrum image when there is a ball fault in 0.021-inch bearing.

FIGS. 11 and 12 are diagrams showing a primitive signal and a Mel spectrum image when there is an inner race fault in 0.007-inch bearing.

FIGS. 13 and 14 are diagrams showing a primitive signal and a Mel spectrum image when there is an inner race fault in 0.014-inch bearing.

FIGS. 15 and 16 are diagrams showing a primitive signal and a Mel spectrum image when there is an inner race fault in 0.021-inch bearing.

FIGS. 17 and 18 are diagrams showing a primitive signal and a Mel spectrum image when there is an outer race fault in 0.007-inch bearing.

FIGS. 19 and 20 are diagrams showing a primitive signal and a Mel spectrum image when there is an outer race fault in 0.014-inch bearing.

FIGS. 21 and 22 are diagrams showing a primitive signal and a Mel spectrum image when there is an outer race fault in 0.021-inch bearing.

FIGS. 23 and 24 are diagrams showing a primitive signal and a Mel spectrum image when a valve is in a normal state.

FIGS. 25 and 26 are diagrams showing a primitive signal and a Mel spectrum image when a valve is in an abnormal state.

FIGS. 27 and 28 are diagrams showing a primitive signal and a Mel spectrum image when a pump is in a normal state.

FIGS. 29 and 30 are diagrams showing a primitive signal and a Mel spectrum image when a pump is in an abnormal state.

FIGS. 31 and 32 are diagrams showing a primitive signal and a Mel spectrum image when a fan is in a normal state.

FIGS. 33 and 34 are diagrams showing a primitive signal and a Mel spectrum image when a fan is in an abnormal state.

FIGS. 35 and 36 are diagrams showing a primitive signal and a Mel spectrum image when slide rails are in a normal state.

FIGS. 37 and 38 are diagrams showing a primitive signal and a Mel spectrum image when slide rails are in an abnormal state.

### BEST MODE

Hereinafter, concrete embodiments of the inventive concept will be described in detail with reference to the drawings.

In the following description of the inventive concept, detailed description of known related configurations and functions will be omitted when it is determined that the gist of the inventive concept may be unnecessarily obscured.

The embodiments of the inventive concept are provided to more completely explain the inventive concept to those skilled in the art, and the following embodiments may be modified in many different forms, and the scope of the inventive concept is not limited to the following embodiments.

Rather, these embodiments are provided so that this disclosure will be thorough and complete, and will fully convey the scope of the inventive concept to those skilled in the art.

In addition, each component in the following drawings is exaggerated for convenience and clarity of explanation, and the same reference numerals refer to the same elements in the drawings. As used herein, the term “and/or” includes any one and all combinations of one or more of the listed items.

The terminology used herein is for the purpose of describing particular embodiments only and is not intended to be limiting of the inventive concept.

As used herein, the singular form is intended to include the plural form as well, unless the context clearly indicates otherwise. It will be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

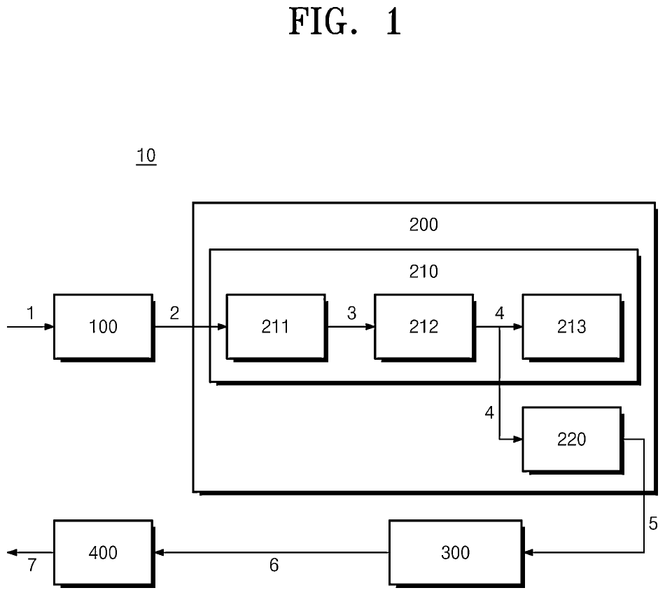

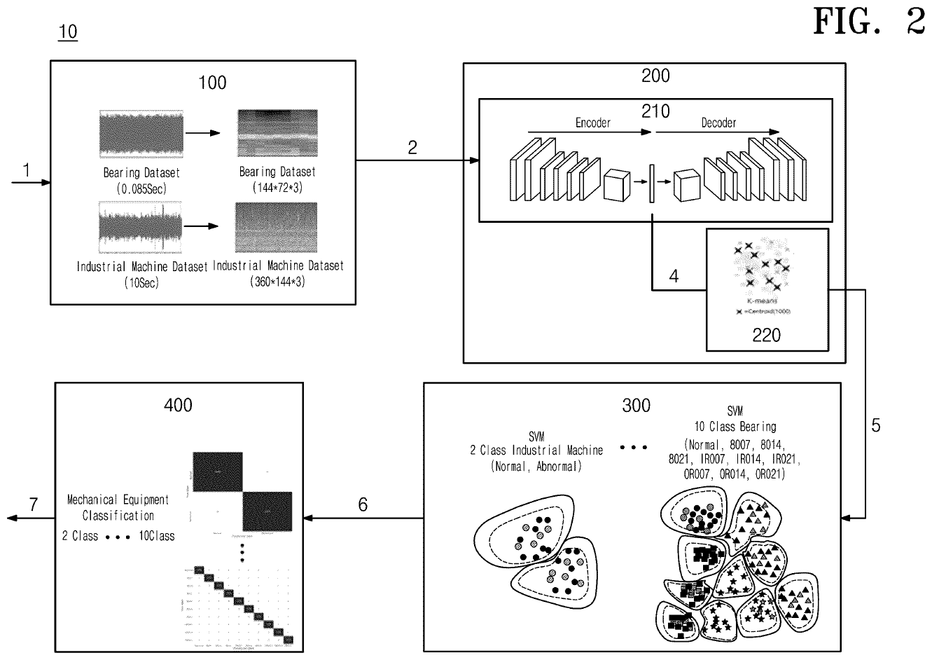

FIG. 1 is a diagram schematically showing a system 10 for diagnosing a machine failure according to an embodiment of the inventive concept, and FIG. 2 is a diagram schematically illustrating a data flow performed in each configuration of FIG. 1.

Referring to FIGS. 1 and 2, the system 10 for diagnosing a machine failure may include a preprocessing module 100, a feature extraction module 200, a failure diagnosis module 300, and a result output module 400.

The preprocessing module 100 may be configured to receive a primitive signal 1 in a time-amplitude domain and generate a Mel spectrum image 2 in a time-frequency domain.

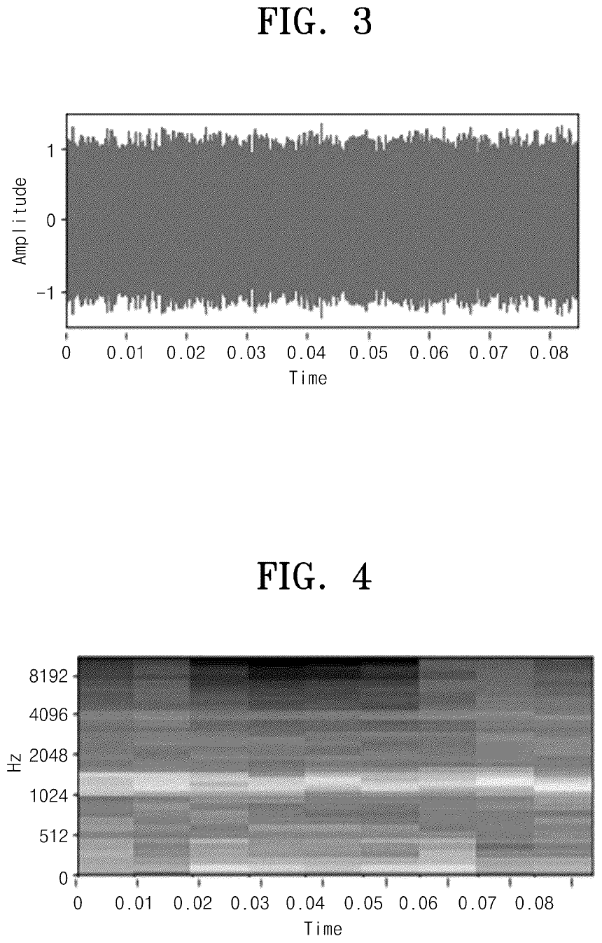

The primitive signal 1 and the Mel spectrum image 2 may be provided as shown in FIGS. 3 to 38 below.

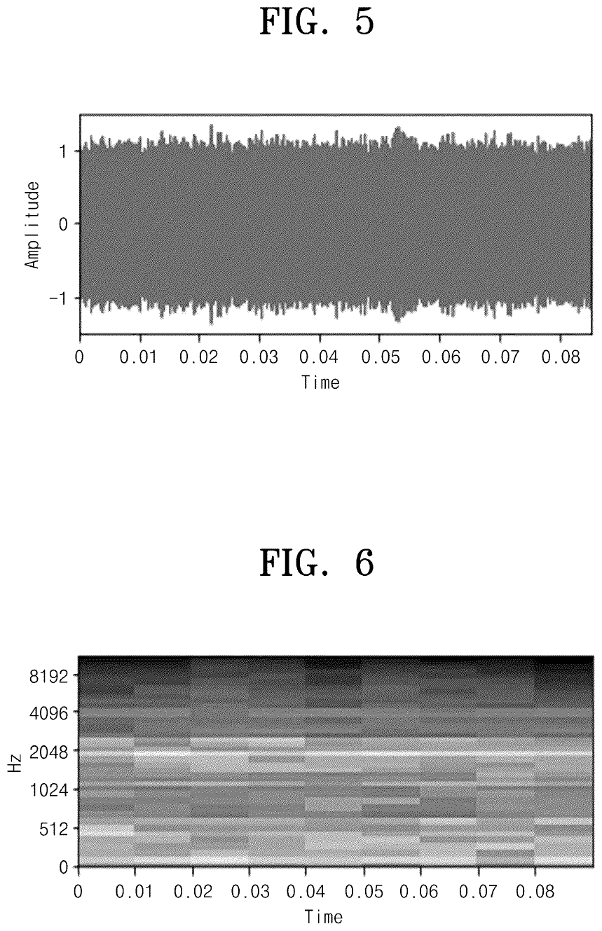

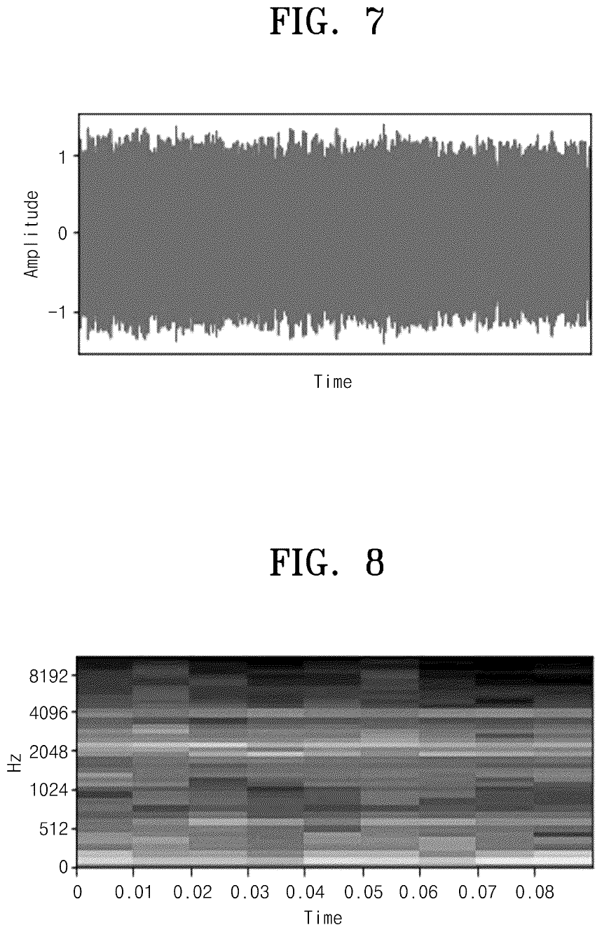

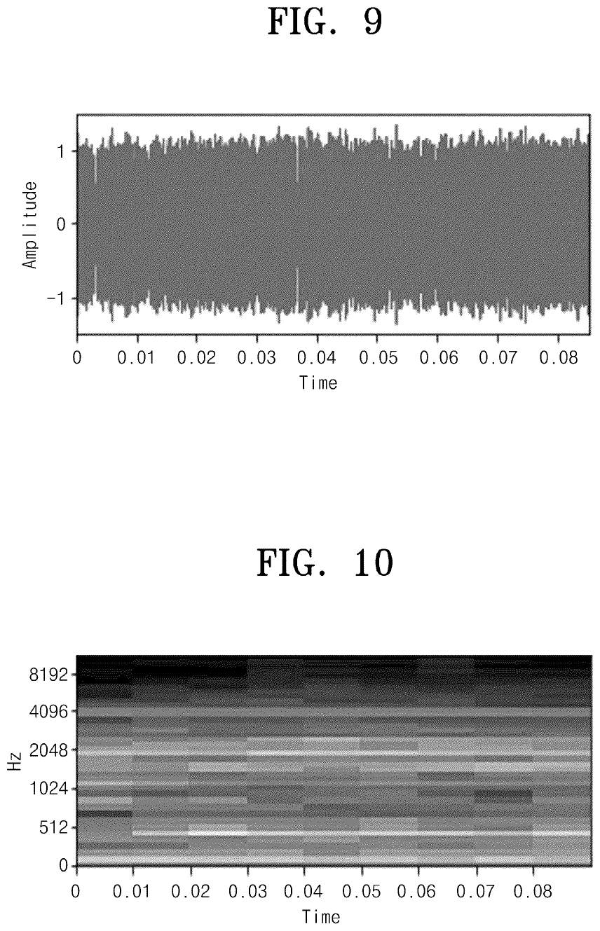

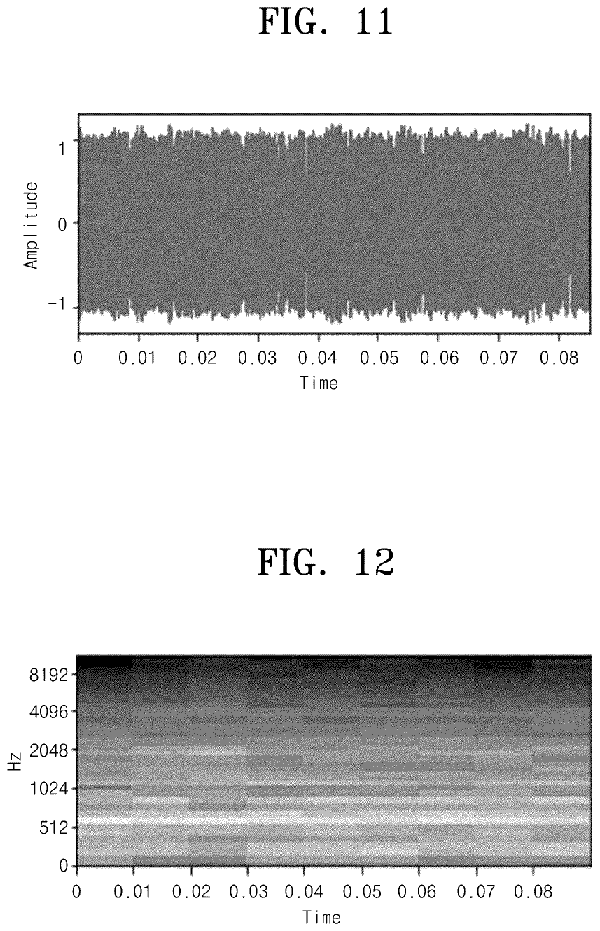

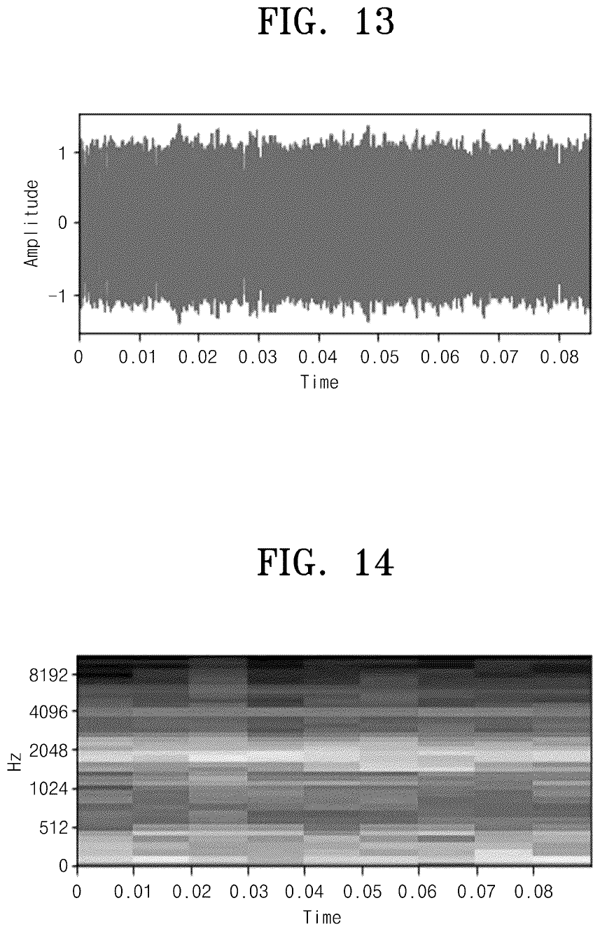

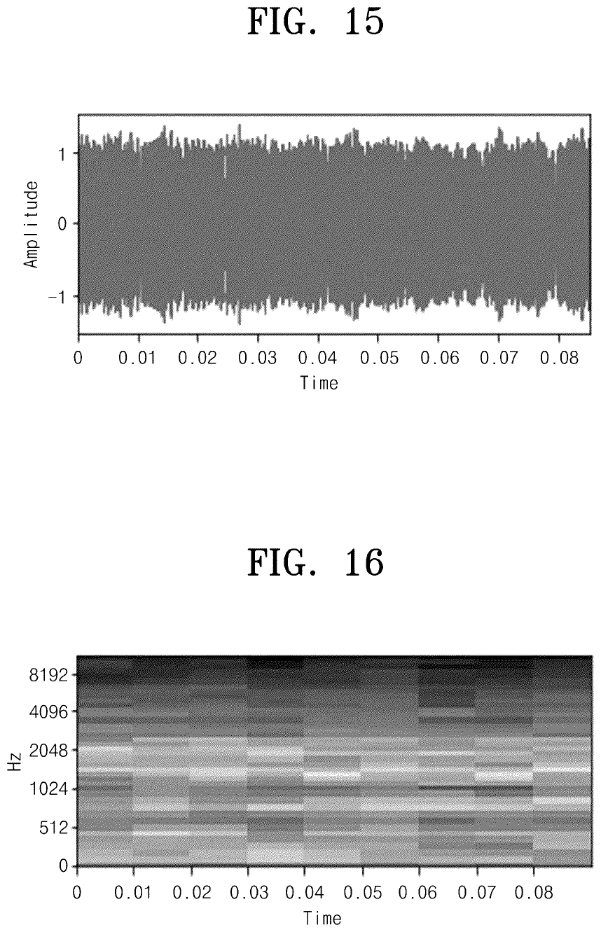

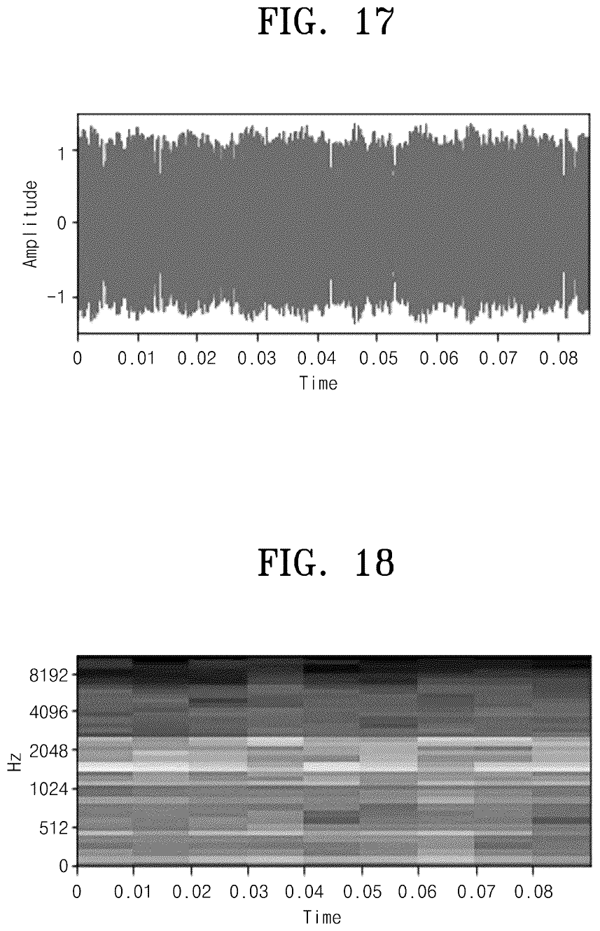

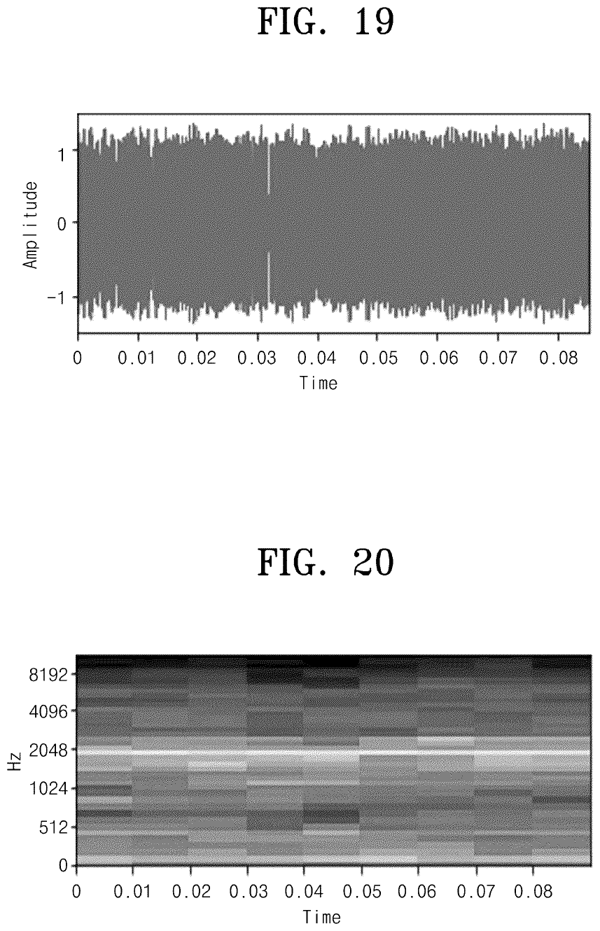

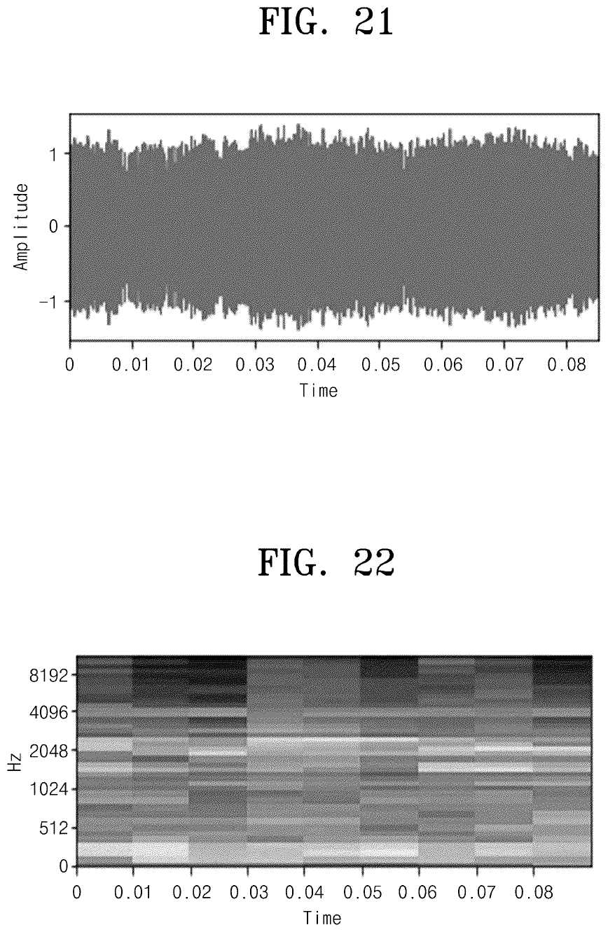

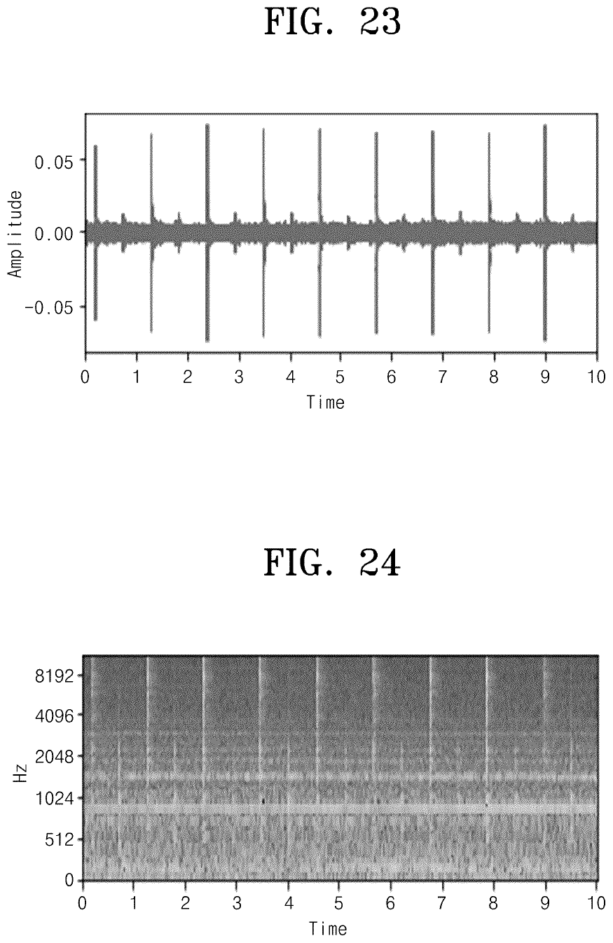

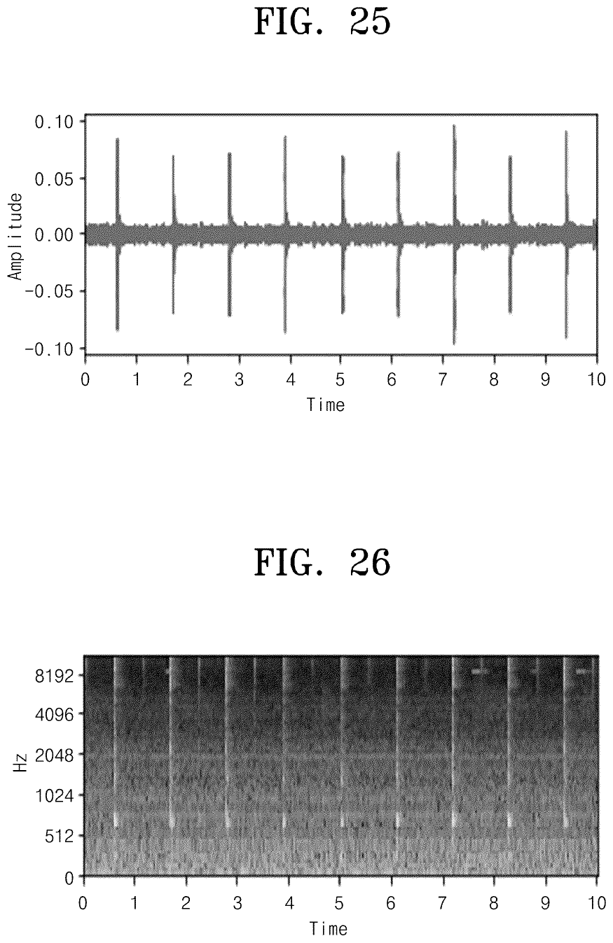

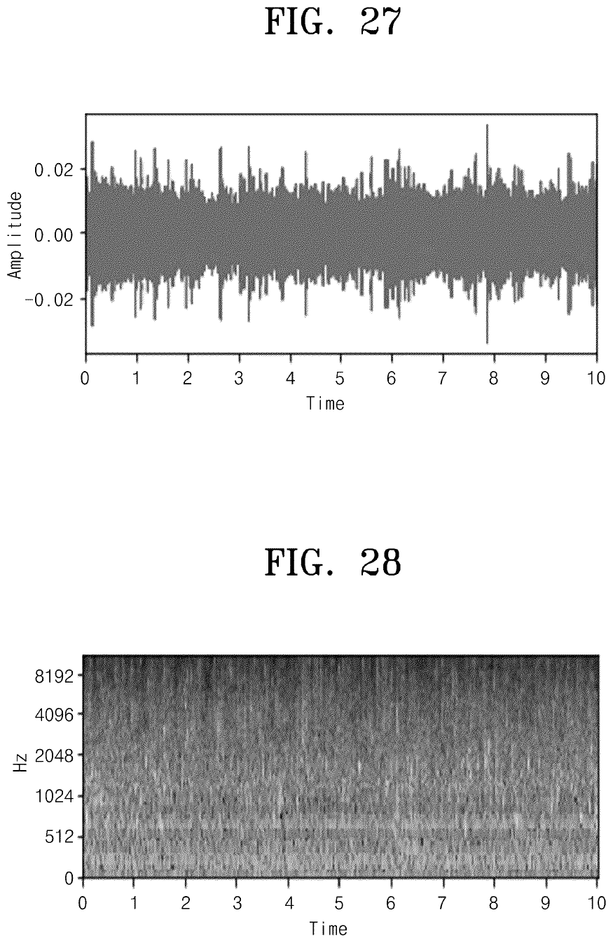

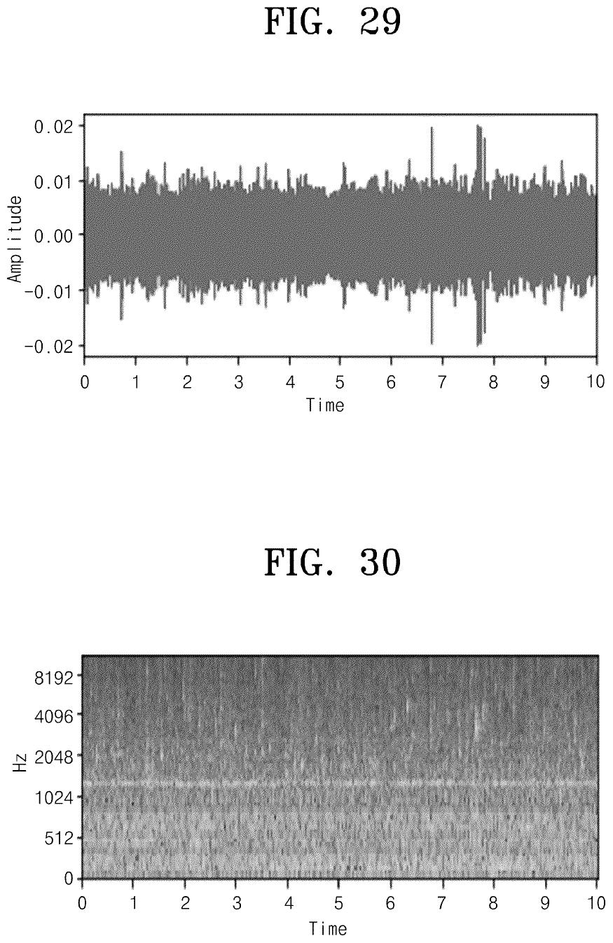

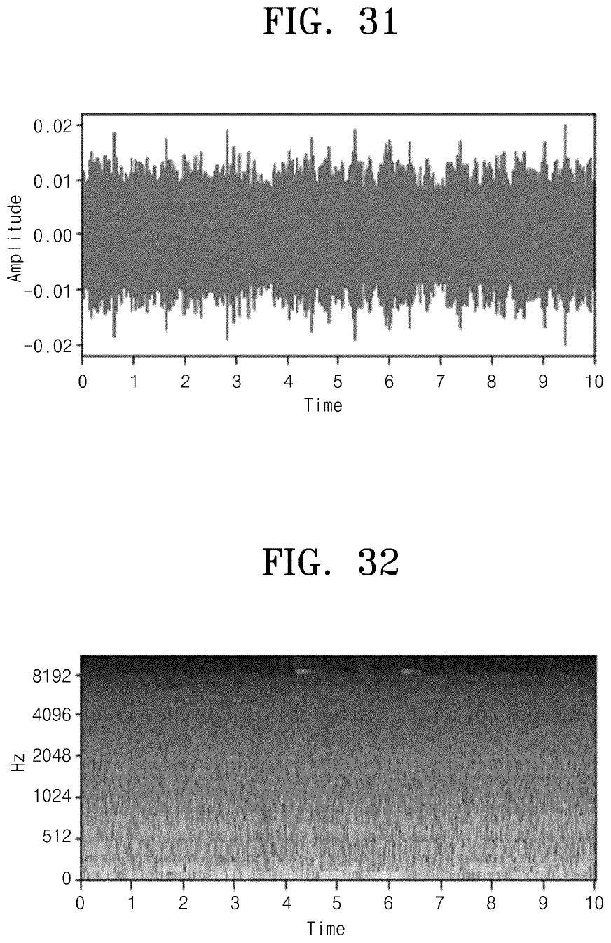

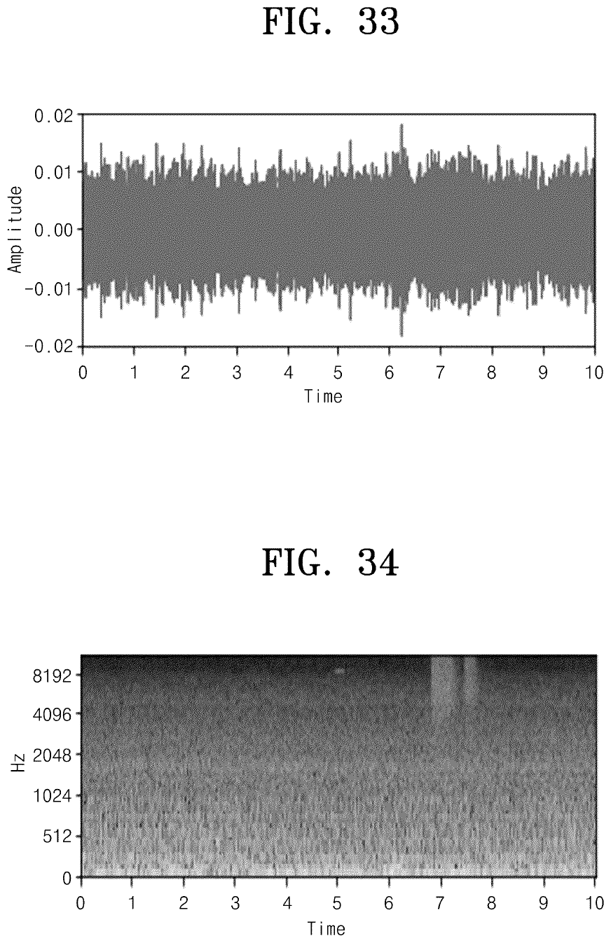

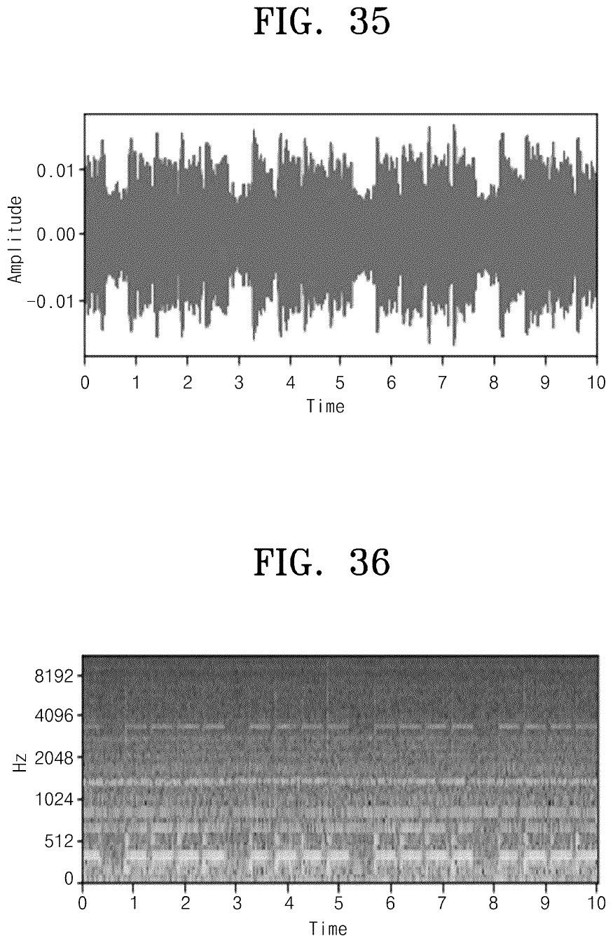

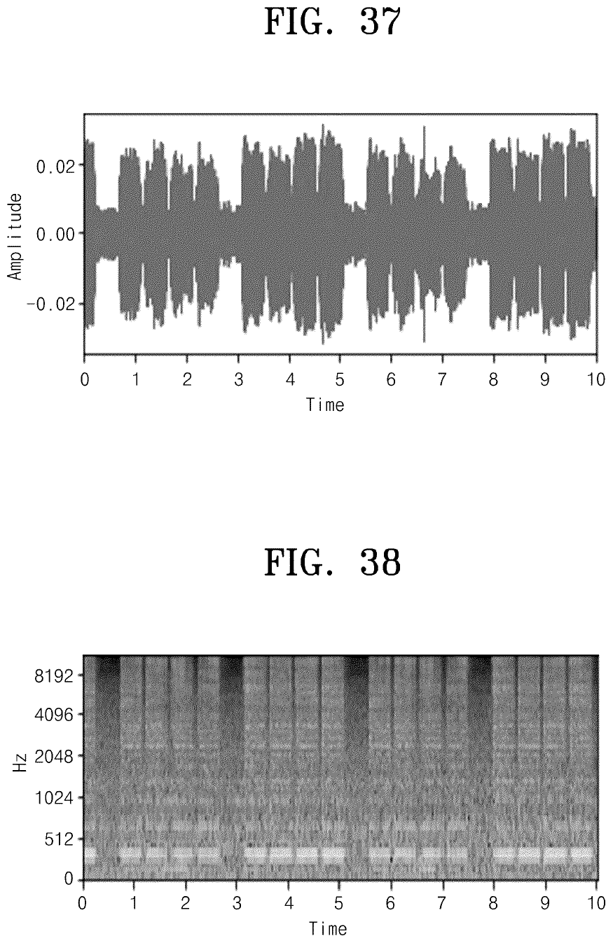

FIGS. 3 and 4 are diagrams showing a primitive signal and a Mel spectrum image when a bearing is in a normal state, FIGS. 5 and 6 are diagrams showing a primitive signal and a Mel spectrum image when there is a ball fault in 0.007-inch bearing, FIGS. 7 and 8 are diagrams showing a primitive signal and a Mel spectrum image when there is a ball fault in 0.014-inch bearing, FIGS. 9 and 10 are diagrams showing a primitive signal and a Mel spectrum image when there is a ball fault in 0.021-inch bearing, FIGS. 11 and 12 are diagrams showing a primitive signal and a Mel spectrum image when there is an inner race fault in 0.007-inch bearing, FIGS. 13 and 14 are diagrams showing a primitive signal and a Mel spectrum image when there is an inner race fault in 0.014-inch bearing, FIGS. 15 and 16 are diagrams showing a primitive signal and a Mel spectrum image when there is an inner race fault in 0.021-inch bearing, FIGS. 17 and 18 are diagrams showing a primitive signal and a Mel spectrum image when there is an outer race fault in 0.007-inch bearing, FIGS. 19 and 20 are diagrams showing a primitive signal and a Mel spectrum image when there is an outer race fault in 0.014-inch bearing, FIGS. 21 and 22 are diagrams showing a primitive signal and a Mel spectrum image when there is an outer race fault in 0.021-inch bearing, FIGS. 23 and 24 are diagrams showing a primitive signal and a Mel spectrum image when a valve is in a normal state, FIGS. 25 and 26 are diagrams showing a primitive signal and a Mel spectrum image when a valve is in an abnormal state, FIGS. 27 and 28 are diagrams showing a primitive signal and a Mel spectrum image when a pump is in a normal state, FIGS. 29 and 30 are diagrams showing a primitive signal and a Mel spectrum image when a pump is in an abnormal state, FIGS. 31 and 32 are diagrams showing a primitive signal and a Mel spectrum image when a fan is in a normal state, FIGS. 33 and 34 are diagrams showing a primitive signal and a Mel spectrum image when a fan is in an abnormal state, FIGS. 35 and 36 are diagrams showing a primitive signal and a Mel spectrum image when slide rails are in a normal state, and FIGS. 37 and 38 are diagrams showing a primitive signal and a Mel spectrum image when slide rails are in an abnormal state.

The preprocessing module 100 may receive the primitive signal 1 corresponding to FIG. 3, FIG. 5, FIG. 7, FIG. 9, FIG. 11, FIG. 13, FIG. 15, FIG. 17, FIG. 19, FIG. 21, FIG. 23, FIG. 25, FIG. 27, FIG. 29, FIG. 31, FIG. 33, FIG. 35, and FIG. 37, perform Fourier Transform on the primitive signal 1 and then apply a Mel filter to generate the Mel spectrum image 2 corresponding to FIG. 4, FIG. 6, FIG. 8, FIG. 10, FIG. 12, FIG. 14, FIG. 16, FIG. 18, FIG. 20, FIG. 22, FIG. 24, FIG. 26, FIG. 28, FIG. 30, FIG. 32, FIG. 34, FIG. 36, and FIG. 38.

The Mel spectrum image 2 generated by the preprocessing module 100 may be used for learning of an autoencoder unit 210 included in the feature extraction module 200 to be described later.

In addition, when the primitive signal 1 for machine failure diagnosis is input to the preprocessing module 100 after learning in the autoencoder unit 210 has been completed, the preprocessing module 100 may convert the primitive signal 1 into the Mel spectrum image 2 and input the Mel spectrum image 2 to the feature extraction module 200. An output value output from the feature extraction module 200 may be then input to the failure diagnosis module 300 and the result output module 400, and used to determine whether a machine or part generating the primitive signal 1 is in a faulty state or a normal state.

Referring back to FIGS. 1 and 2, the feature extraction module 200 may include the autoencoder unit 210 configured to extract time-series patterns from the Mel spectrum image 2 output from the preprocessing module 100 and learn features of the time-series patterns.

The autoencoder unit 210 may include an encoder 211, a full connection layer 212, and a decoder 213, and may learn the features of the Mel spectrum image 2 input from the preprocessing module 100.

The autoencoder unit 210 may include the encoder 211, the full connection layer 212, and the decoder 213.

The encoder 211 may include a CNN (Convolution Neutral Network) layer, a Pooling layer, and a Long Short Term Memory (LSTM) layer, and may receive the Mel spectrum image 2 input from the preprocessing module 100 and output time-series features 3.

The full connection layer 212 receiving the time-series features 3 output from the encoder 211 may output a latent variable 4.

The decoder 213 may include a Long Short Term Memory (LSTM) layer, a Convolution Neutral Network (CNN) layer, and an Up Sampling layer, and may receive the latent variable 4 output from the full connection layer 212 and again perform restoration to the size of the Mel spectrum image.

The autoencoder unit 210 may calculate an error (Mean of Squared Error: MSE) through Equation 1 below, and may perform learning through a process of reducing the calculated error MSE.

$$MSE = \frac{1}{N} {\sum }_{i = 1}^{N} {( {y}_{i} - {y}_{i}^{′} )}^{2} . \qquad ( Equation 1 )$$

MSE: a Mean of Squared Error, Error
yᵢ: a latent variable
y′ᵢ: a predicted value of the latent variable

The feature extraction module 200 may include a Euclidean distance output unit 220 configured to output a Euclidean distance between each latent variable 4 output from the full connection layer 212 and the centroid using a K-means clustering algorithm.

The operation process of the Euclidean distance output unit 220 using the K-means clustering algorithm will be described below.

First, the Euclidean distance output unit 220 may set a preset number of clusters and a centroid of each of the clusters.

For example, 1000 clusters may be set, and in this case, 1000 centroids respectively corresponding to the centers of the clusters may also be set. However, the number of clusters may be changed according to user settings.

Next, the latent variable 4 input from the full connection layer 212 may be set as a sample of a cluster to which a centroid having the closest Euclidean distance among a plurality of centroids belongs.

Next, the position of each centroid may be changed to the average position of the samples belonging to a corresponding cluster.

Finally, when there is no change in the position of the centroid, the Euclidean distance between each latent variable 4 and each centroid may be output.

The Euclidean distance 5 between each latent variable and each centroid, which is output from the Euclidean distance output unit 220, may be input to the failure diagnosis module 300.

The Euclidean distance output unit 220 may calculate the Euclidean distance 5 between each latent variable and each centroid through Equation 2 below.

$${D}_{( i , j )} = {\sum }_{j = 1}^{k} {\sum }_{i = 1}^{n} {‖ {x}_{i}^{( j )} - {μ}_{j} ‖}^{2} \qquad ( Equation 2 )$$

D_{(i,j)}: a distance between the latent variable and the centroid
xᵢ^{(j)}: a position of the latent variable
μⱼ: a position of the centroid
Referring back to FIGS. 1 and 2, the failure diagnosis module 300 may perform classification into a preset number of classes based on the Euclidean distance 5 between each latent variable and each centroid, which is output from the Euclidean distance output unit 220.

To this end, the failure diagnosis module 300 may receive, from a user, the preset number of classes for determining failure. In this case, the number of classes may be adjusted according to the user's selection.

For example, when the user wants to determine only whether a machine is Normal or Abnormal, the number of classes may be input as two. In this case, the failure diagnosis module 300 may group Euclidean distances 5 between latent variables and centroids for bearing, valve, pump, fan, and slide rail in a normal state into a normal class, and group Euclidean distances 5 between latent variables and centroid for the others into an abnormal class.

As another example, when the user wants to determine which part of bearings of different sizes (0.007/0.014/0.021 inches) has a failure (ball defect/inner race defect/outer race defect), the number of classes may be to 10 or more. In this case, the failure diagnosis module 300 may group the Euclidean distance 5 between a centroid and a latent variable for a bearing in a normal state as a normal class, and group the Euclidean distances 5 between centroids and latent variables for the rest nine bearings in an abnormal state as different classes.

Thereafter, the failure diagnosis module 300 may find the boundaries of features located in a vector space using the SVM (Support Vector Machine) algorithm, maximize margins, and perform classification into a preset number of classes to classify the Euclidean distance 5 between each latent variable generated from a primitive signal 1 to be diagnosed for failure and each centroid to determine which class the Euclidean distance 5 belongs to, according to the number of classes.

For example, when the failure diagnosis module 300 receives 10 classes for determining failure, the SVM algorithm may be applied to the Euclidean distance 5 between the centroid and the latent variable generated when the primitive signal 1 to be diagnosed for failure passes through the feature extraction module 200 to find the boundaries of the features located in the vector space, maximize margins and perform classification into a preset number of classes, thereby classifying the Euclidean distance 5 into any one of the 10 classes.

Referring back to FIGS. 1 and 2, the result output module 400 may output whether there is a failure according to the class classified by the failure diagnosis module 300.

For example, when the Euclidean distances 5 between latent variables and centroids are classified into two classes, and the primitive signal 1 to be diagnosed for failure is classified into a normal class among the two classes in the failure diagnosis module 300, the result output module 400 may output a result indicating that a machine generating the corresponding primitive signal 1 is in a normal state, that is, the machine does not have a failure.

As another example, when the Euclidean distances 5 between latent variables and centroids is classified into 10 classes for bearings, and the primitive signal 1 to be diagnosed for failure is classified into a class of 0.007-inch ball defeat among the 10 classes in the failure diagnosis module 300, the result output module 400 may output a result indicating that a ball defect is present in a 0.007-inch bearing in a machine that has generated the corresponding primitive signal 1.

Although the inventive concept has been described through the embodiments above, the above embodiments are only for explaining the idea of the inventive concept and are not limited thereto. Those skilled in the art will understand that various modifications can be made to the above-described embodiments. The scope of the inventive concept is defined only through the interpretation of the appended claims.

1. A system for diagnosing a machine failure, comprises:
a pre-processing module configured to receive a primitive signal in a time-amplitude domain to generate a Mel spectrum image in a time-frequency domain;
a feature extraction module configured to learn features of the Mel spectrum image to output an Euclidean distance between a latent variable and a centroid;
a failure diagnosis module configured to perform classification into a preset number of classes on the basis of the Euclidean distance between the latent variable and the centroid; and
a result output module configured to output whether a failure has occurred according to a class classified by the failure diagnosis module.

2. The system of claim 1, wherein the feature extraction module includes an autoencoder unit configured to extract time-series patterns from the Mel spectrum image and learn the features.

3. The system of claim 2, wherein the autoencoder unit includes:
an encoder configured to receive the Mel spectrum image through a CNN layer, a pooling layer, and an LSTM layer and output time-series features;
a full connection layer configured to output a latent variable by receiving the time-series features; and
a decoder configured to receive the latent variable through the LSTM layer, the CNN layer, and an Up Sampling layer and perform restoration to the Mel spectrum image.

4. The system of claim 3, wherein the feature extraction module further includes an Euclidean distance output unit configured to output an Euclidean distance between a centroid and the latent variable output from the full connection layer using a K-means clustering algorithm.

5. The system of claim 4, wherein the Euclidean distance output unit is configured to:
set a preset number of clusters and a centroid of each of the clusters;
set the latent variable as a sample of a cluster to which a centroid with a closest Euclidean distance belongs;
change a position of the centroid to an average position of samples belonging to each cluster; and
output Euclidean distances between the latent variables and the centroids when there is no change in the position of the centroid.

6. The system of claim 5, wherein the failure diagnosis module is configured to:
receive a preset number of classes for determining whether or not there is a failure; and
classify the Euclidean distances between the latent variables and the centroids according to the number of classes by finding boundaries of features located in the vector space using an SVM algorithm, maximizing margins, and classifying the Euclidean distances into the preset number of classes.
